(19) United States
(12) Patent Application Publication
(10) Pub. No.: US 2006/0175824 A1
(43) Pub. Date: Aug. 10, 2006

(54) Method for printing a security element and security element

(76) Inventors: Fausto Giori, Lausanne (CH); Gianfranco Foresti, Ecublens (CH)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 10/543,987

(22) PCT Filed: Feb. 5, 2004
(86) PCT No.: PCT/IB04/00398

§ 371 Date: Apr. 10, 2006

(30) Foreign Application Priority Data
Feb. 13, 2003 (EP) 03003331.0

(51) Int. Cl. B42D 15/00

(52) U.S. Cl. 283/72

(57) ABSTRACT

The method comprises the following steps: printing of a background on the substrate, semi-transparent printing of a motif with optically variable ink, said motif at least partially covering said background

### BACKGROUND OF THE INVENTION

The present invention relates to a method for printing a security element for paper securities, such as banknotes, checks, credit cards, passports or identity documents and other similar documents for example.

The present invention also relates to a security element for paper securities, such as banknotes, passports, identity documents and the like.

In the field of paper securities, particularly banknotes, there is an increasing need for security elements as protection against forgery. In the last few years, computers, scanners and photocopiers have undergone appreciable technical improvements and it is currently possible to purchase high-performance equipment at a reasonable price. As the performance of this equipment has become very good, it has become necessary to develop new security elements, which themselves also perform better, for paper securities such as banknotes, checks, credit cards, passports or identity documents and other similar documents so as to protect these documents against forgery and prevent them from being able to be copied by present-day computers, scanners and photocopiers.

Such security elements use, for example, special-purpose inks such as optically variable inks (“OVI”®) and other inks that have iridescent properties, these inks being used to print special patterns or geometric shapes on the substrate of the paper security, optically variable devices (“OVD”®) in the form of metallized patches (known as “foils”) or holograms, and also moirés and other similar patterns, all of these being, on the one hand, very difficult if not impossible to copy with current equipment and also, on the other hand, very easy to check visually or with the naked eye.

Other security elements are formed of combinations of superposition of lines and/or patterns with colors, which are visible only under certain conditions, for example under UV light or by transparency. Once again, the benefit of such security elements is that they are easy to print or to place on the document that is to be protected and can be checked using simple equipment, even using the naked eye, but are impossible to reproduce using present-day printers, scanners and photocopiers.

### DESCRIPTION OF THE PRIOR ART

By way of example, patent U.S. Pat. No. 6,050,606 incorporated by reference into this application, describes a security element for paper securities, for example for banknotes. This security element is formed of a background having at least two juxtaposed regions, each region comprising its own geometric designs, said regions having a different color density. The security element further comprises a pattern corresponding to the region of lowest color density which is printed in superposition on said region in a chosen color so as to compensate for the difference in color density between said two regions. Thus, the security element appears uniform and patternless to the naked eye, but the pattern becomes clearly visible if said element is photocopied.

Patent U.S. Pat. No. 5,443,579, incorporated by reference into this application, describes another method for printing a latent image on a substrate. According to that patent, the printing of lines in relief is combined with the printing of lines without relief. Thus, a latent color image is created that cannot be reproduced with a photocopier or other photomechanical methods.

Patents U.S. Pat. No. 5,853,197 and U.S. Pat. No. 5,487,567, incorporated by reference into this application, display security elements which are not easily visible to the naked eye but which, by contrast, become clearly evident when the element is reproduced by photocopying or scanning.

Another specific technique employs watermarks in which the substrate, for example paper, is marked with lines or a pattern which are visible only in transparency. A development of this technique relates to pseudo-watermarks formed by the creation of a window in the substrate, this technique being used in particular with paper substrates which are not themselves normally transparent, said window for its part being transparent.

Patent U.S. Pat. No. 6,082,778, the content of which is incorporated by reference into this application, describes an identity card protected against unauthorized copying by photocopiers. In that patent, the idea is to create a security element by combining the effect of protection afforded by a thin film of metal with the physical, particularly optical, properties of an additional layer the combination of the effects of which prevents the card from being reproduced. Under a transparent cover layer there is a layer of metal over the top of a layer having specific optical properties. In a first embodiment, the layer of metal is locally demetallized thus exposing the layer with specific optical properties, that is to say rendering it visible in the demetallized zone. The difference in contrast between these layers makes the marks formed by demetallization easy to recognize with the naked eye. In one particular embodiment, the layer with specific optical properties has a dark color, for example is black. The combination of the direct reflection of the metallized zone and of a layer having high absorption (a black layer) prevents the difference in contrast from being detected so that the information formed by the demetallization completely disappears on a copy of this security element.

According to other techniques known in the prior art, use is made of a laser either to mark the substrate directly or to mark a layer applied to said substrate and thus create security elements that cannot be reproduced by a photocopier or scanner.

### SUMMARY OF THE INVENTION

One object of the invention is to define an improved printing method for a security element used particularly on paper securities.

Another object of the invention is to create a security element for paper securities improving the elements already known and requiring a method that is simple and easy to implement.

Another object of the invention is to make available a security element that is very difficult to copy and to forge with standard modern photocopiers and scanners and other equivalent equipment but which can be easily printed with present-day printing means.

To this end, the method according to the invention is defined by the steps in claims 1 to 5 and the security element according to the invention is defined by the characteristics of claims 6 to 9.

### DESCRIPTION OF THE DRAWINGS

The description of several embodiments and of the figures relating to them will allow for a better understanding of the invention.

FIG. 1 shows a block diagram of the printing method forming a security element according to the invention.

FIG. 2 shows a first embodiment of a security element according to the invention.

FIG. 3 shows a second embodiment of a security element according to the invention.

FIG. 4 shows a paper security comprising a security element according to the invention.

### DESCRIPTION OF THE PREFERRED EMBODIMENTS

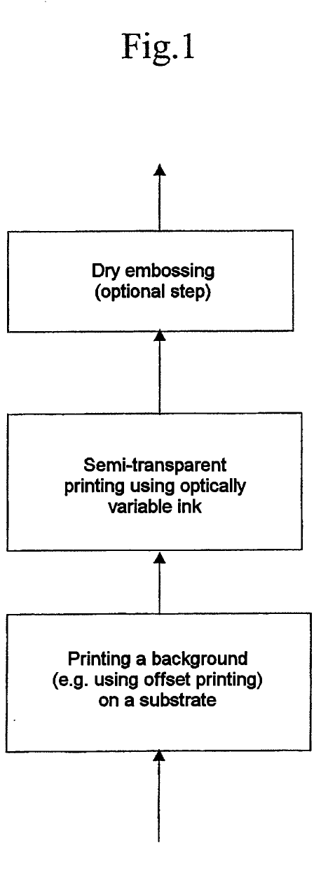

FIG. 1 depicts one embodiment of the method according to the invention in the form of a block diagram. In the first step, a background is first of all printed onto the substrate, for example using an offset method known from the prior art. The background may be monochrome or polychrome, it being possible for such printing to be performed using the known methods of the prior art. According to this method, the pattern which will be printed is transferred from an offset plate cylinder inked by inking rolls onto a blanket cylinder which in turn transfers the pattern onto the substrate, for example paper. Patent application FR 2 222 214 describes an offset printing method and an offset printing press. The content of that application, particularly the part regarding the offset printing is incorporated by reference into this application. By way of another example, patent U.S. Pat. No. 6,101,939, the content of which is incorporated by reference into this application, describes another printing press using the offset method. This background may extend over the entire surface of the paper security or be restricted to a particular region thereof.

Over the top of the printing of said background, a semi-transparent pattern is then printed using an appropriate printing method and using an optically variable ink. Such inks, which have iridescent properties, contain particles of metal and are generally applied in the form of an opaque pattern to the paper securities, said pattern forming a security element. This is because, owing to the presence of metal particles, these patterns formed of optically variable ink change color according to the angle from which they are viewed, the colors depending both on the color of the ink itself and on the metal particles. Such inks are particularly good for forming security elements because it is not possible to reproduce the iridescent effect using color photocopiers or scanners: when copied, the pattern formed of the optically variable ink loses in particular its iridescent properties which means that a copy is easy to identify with the naked eye.

As a preference, the semi-transparent pattern in optically variable ink is printed using a screen printing method. Such a printing method is well known by itself in the prior art. According to this method, the pattern that is to be printed is formed using a screen through which the ink is applied to the substrate, for example the paper security. For positive printing, the holes in the screen are closed except for the pattern, which means the ink passes through the screen to form the pattern itself on the substrate, whereas for negative printing, the holes corresponding to the pattern are blocked off and the ink identifies the outline of the pattern, the pattern itself being created by the absence of ink on the substrate. By way of examples, patents U.S. Pat. No. 6,109,172 and U.S. Pat. No. 5,671,671, of which the contents describing screen printing presses, are incorporated by reference into this application.

In the context of the present invention, a given printing method, for example a screen printing method as described hereinabove and in the aforementioned US patents, is combined with optically variable ink, but the fineness of the screen for the screen printing, that is to say the size of the holes in the screen, is chosen so that the pattern created by screen printing using optically variable ink is semi-transparent. Thus, on the one hand, the printed background can be seen on the substrate through the semi-transparent pattern of optically variable ink but, on the other hand, as said pattern is formed with optically variable ink, it maintains iridescent properties due to the optically variable ink. This then combines two particular optical effects that are very difficult to reproduce satisfactorily: on the one hand, semi-transparency and, on the other hand, the iridescence of the optically variable ink. In addition, a combination of at least three superposed colors (the background color and the two colors of the optically variable ink) is obtained which varies according to the angle from which the pattern is viewed, the entity thus forming a particularly good security element.

In the case of a screen printing method, the fineness of the screen is of the order of 180 to 230 lines per inch, in each direction, X and Y, of the screen. As a preference, a fineness of the order of 230 lines per inch is chosen. Of course, the fineness of the screen can be adapted to suit the optically variable ink used and, in particular, the size of the metal particles contained in said ink, the purpose being to obtain a semi-transparent printing with the optically variable ink. These parameters may of course be optimized through simple print trials in order to adjust the size of the holes and therefore the quantity of ink deposited during the printing in order to obtain the desired effect.

Other printing methods allowing a semi-transparent pattern in optically variable ink to be deposited are of course possible, particularly a photogravure method or a flexographic method, and the present invention is not restricted to screen printing, the desired goal, as indicated hereinabove, being to obtain a semi-transparent pattern with an optically variable ink. These methods are known from the prior art, for example from publication DE 35 35 993 in the case of flexography.

In the case of a photogravure method, use is preferably made of a printing forme having a screen fineness of the order of 60 to 120 lines per centimeter, the screen angle of which can vary from 0° to 75° and the depth of the engraved cavities of which is between 10 microns and 50 microns. These parameters may of course be adapted to suit the type of optically variable ink used and the degree of transparency that it is desired be obtained. The adjusting of these parameters may in particular be achieved through comparative tests.

In the case of a flexographic printing method, use is made of an anylox cylinder having a screen ruling of the order of 100 to 120 lines per centimeter, the depth of the cells of which is between 30 microns and 50 microns. The parameters may be adapted according to the type of optically variable ink used and the degree of transparency that it is desired be obtained.

In the third step of the method, which is optional, a step of dry embossing the security element is then performed. This step makes it possible to form an additional and raised pattern in the security element created by the superposition of the background and the semi-transparent printing, which raised pattern can of course also not be reproduced by photocopying or scanning. In order to perform this embossing, use may be made of an intaglio method that is conventional in the field of printing, omitting the use of ink in order to obtain dry embossing. This pattern is also visible only when the security element is viewed from a particular angle and also, in such an embodiment, combines the effects of color, iridescence and a tactile effect through the raised pattern.

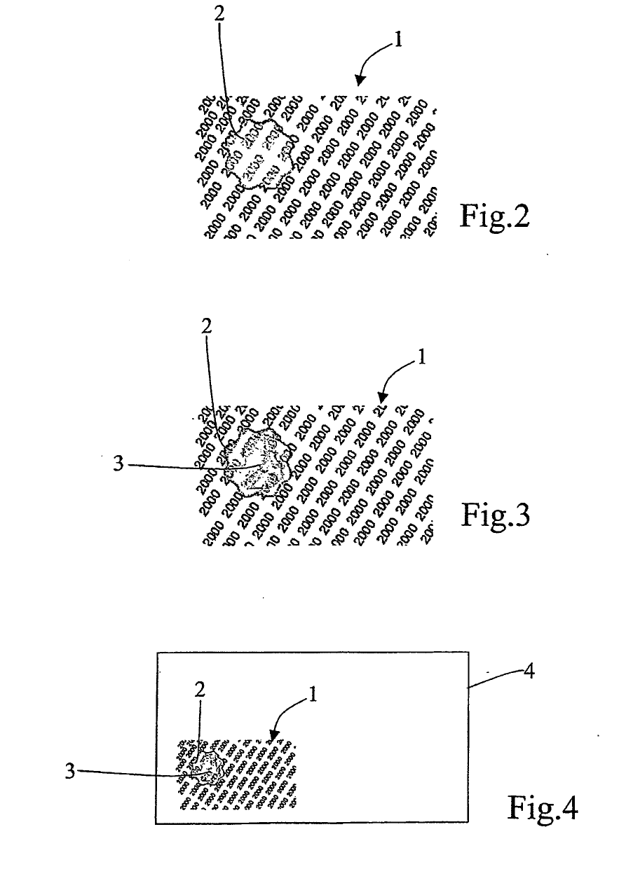

A security element according to the invention is described with reference to FIGS. 2 to 4.

FIG. 2 shows a security element according to the invention with a background 1, printed for example using offset printing, and which comprises the alphanumeric characters “2000” placed beside each other. Over the top of this background a semi-transparent pattern 2 has been printed using an optically variable ink. Although optically variable ink is used for the pattern 2, which pattern is normally opaque because of the optically variable ink, the method used to print the pattern 2 is such that said pattern is semi-transparent, which means that the background 1 is visible through the pattern 2. As indicated hereinabove, one method that can be used for creating the semi-transparent pattern using optically variable ink is a screen printing method in which the screen has a particular fineness, namely 180 to 230 lines per inch.

A pattern is thus obtained that has both the properties of a printed pattern with optically variable ink and additionally has an effect of semi-transparency allowing the background on which it is printed to be seen.

FIG. 3 demonstrates the various elements that make up the security element according to the invention in a particular embodiment. There is still the background 1 comprising the characters “2000” repeated uniformly, then the semi-transparent pattern 2 in optically variable ink can be discerned, through which it is possible to see the characters of the background because of the semi-transparent effect. It is also possible to discern a raised pattern 3, in this instance a face, which has been formed, for example, by dry embossing the security element.

A degree of security is thus added to the element, in that not only is it semi-transparent, and has the characteristics of a security element made of optically variable ink, but it also includes a raised pattern by dry embossing, all these various properties being very difficult, if not impossible, to reproduce using a modern photocopier or scanner.

In FIG. 4, a paper security 4 is depicted by way of example with a security element according to the invention. This paper security 4, in this instance a schematic banknote, comprises, in its lower corner, a security element with a background 1, a semitransparent pattern 2 in optically variable ink and a dry embossing 3 as depicted with reference to FIG. 3 of this application. It should be noted that the background 1 may extend over the entire area of the paper security.

In addition, other printing techniques may be used for printing the background 1 and the pattern 2, the important thing for the pattern 2 being that it exhibits both the characteristics of a pattern in optically variable ink and a semi-transparent effect.

1. A method for printing a security element for paper securities such as banknotes and other similar documents onto a substrate, specifically comprising the following steps:
printing a background onto the substrate;
printing a pattern at least partially covering said background using opaque optically variable ink, said pattern being printed using a screen printing method, or a flexographic method or using photogravure, by means, respectively, of a screen, of an anylox cylinder, or of a printing forme the screen fineness or screen ruling of which is chosen so that the printed pattern created using the optically variable ink is semi-transparent and so that said background can be seen through said pattern printed in optically variable ink.

2. The method as claimed in claim 1, wherein the screen used in the screen printing method comprises about 180 to 230 lines per inch in the X and Y directions of said screen.

3. The method as claimed in claim 1, wherein the anylox cylinder used in the flexographic method has a screen ruling of about 100 to 120 lines per centimeter and the depth of the cells of which is between 30 and 50 microns.

4. The method as claimed in claim 1, wherein the printing forme used in the photogravure method has a screen fineness of the order of 60 to 120 lines per centimeter, the screen angle of which can vary from 0 to 75° and the depth of the engraved cavities of which is between 10 and 50 microns.

5. The method as claimed in claim 1, wherein the background is printed using a monochrome or polychrome offset method.

6. The method as claimed in claim 1, and which comprises a step of dry embossing the security element.

7. A security element for paper securities such as banknotes and other similar documents, placed on a substrate, the essential features of said security element being: a printed background on the substrate; a pattern at least partially covering said background, said pattern being semitransparent and formed using opaque optically variable ink according to the method as defined in claim 1 so as to leave said background visible through said pattern printed in optically variable ink.

8. The security element as claimed in claim 7, wherein the background is in offset printing.

9. The security element as claimed in claim 7, and which further comprises dry embossing.

10. A paper security, particularly a banknote or other similar document, and which comprises a security element as claimed in claim 7.

11. The security element as claimed in claim 8, and which further comprises dry embossing.

12. A security element as claimed in claim 7, wherein the screen used in the screen printing method comprises about 180 to 230 lines per inch in the X and Y directions of said screen.

13. A security element as claimed in claim 7, wherein the anylox cylinder used in the flexographic method has a screen ruling of about 100 to 120 lines per centimeter and the depth of the cells of which is between 30 and 50 microns.

14. A security element as claimed in claim 7, wherein the printing forme used in the photogravure method has a screen fineness of the order of 60 to 120 lines per centimeter, the screen angle of which can vary from 0 to 75° and the depth of the engraved cavities of which is between 10 and 50 microns.
